(19) United States
(12) Patent Application Publication
(10) Pub. No.: US 2022/0314587 A1
(43) Pub. Date: Oct. 6, 2022

(54) SURFACE MODIFICATION SHEET FOR SILICONE RUBBER

(71) Applicant: NITTO DENKO CORPORATION, Ibaraki-shi, Osaka (JP)

(72) Inventors: Fumika KAWATAKE, Osaka (JP); Asuka GOMI, Osaka (JP); Kenichi OKADA, Osaka (JP); Akinori TAMURA, Osaka (JP)

(73) Assignee: NITTO DENKO CORPORATION, Ibaraki-shi, Osaka (JP)

(21) Appl. No.: 17/597,263

(22) PCT Filed: Jan. 30, 2020
(86) PCT No.: PCT/JP2020/003305

§ 371 Date: Dec. 30, 2021

(30) Foreign Application Priority Data
Jul. 30, 2019 (JP) 2019-139582

(51) Int. Cl. B32B 27/08; B32B 27/30; B32B 27/28; B32B 7/12; B32B 7/06; C08F 220/18; C08F 220/36; C08J 5/18

(52) U.S. Cl. CPC B32B 27/08; B32B 27/308; B32B 27/283; B32B 7/12; B32B 7/06; C08F 220/1802; C08F 220/1804; C08F 220/1808; C08F 220/36; C08J 5/18; B32B 2250/03; B32B 2250/24; B32B 2333/08; B32B 2383/00

(57) ABSTRACT

A surface modification sheet (X) of the present invention includes a release sheet (10) and a surface modification layer (20) thereon. The surface modification layer (20) contains a polymer having a side chain containing an ethylenic double bond. The side chain of the polymer preferably includes a unit derived from an isocyanate compound containing the ethylenic double bond.

### TECHNICAL FIELD

The present invention relates to a surface modification sheet for silicone rubber.

### BACKGROUND ART

Silicone rubber offers excellent properties such as heat resistance, cold resistance, lire retardancy, and chemical stability, and thus is used in a variety of technical fields. Meanwhile, silicone rubber exhibits a low polarity. The low polarity makes it difficult to bond a bonding material, such as a double-sided adhesive tape or an adhesive, to a molded product of silicone rubber with high adhesive strength. Thus the surface of the silicone rubber-molded product may be modified by primer treatment to increase the adhesive strength between the silicone rubber-molded product and bonding material. Techniques related to modification treatment, including the primer treatment, on the surface of the silicone rubber-molded product are described in, for example, Patent Documents 1-3.

### CITATION LIST

### Patent Document

Patent Document 1: Japanese Published Examined Application No. 61-002107
Patent Document 2: Japanese Unexamined Patent Publication No. H11-209702
Patent Document 3: Japanese Unexamined Patent Publication No. 2016-069290

### SUMMARY OF THE INVENTION

### Problem to be Solved by the Invention

The primer treatment on the surface of a silicone rubber-molded product is burdensome. To be more specific, when a release agent is used in molding a silicone rubber, the release agent is required to be removed from the surface of the molded product before the primer treatment. In addition, the primer treatment in an appropriate manner may require another treatment beforehand. Such primer treatment may cause to reduce the yield in manufacturing of the silicone rubber-molded products.

The present invention provides a silicone rubber surface modification sheet suitable for efficiently producing a silicone rubber-molded product with a modified surface.

### MEANS FOR SOLVING THE PROBLEM

The present invention [1] includes a surface modification sheet for silicone rubber, the surface modification sheet including: a release sheet; and a surface modification layer disposed on the release sheet, and containing a polymer having a side chain containing an ethylenic double bond.

The present invention [2] includes the surface modification sheet for silicone rubber described in [1], wherein the side chain includes a unit derived from an isocyanate compound containing the ethylenic double bond.

The present invention [3] includes the surface modification sheet for silicone rubber described in [2], wherein the isocyanate compound is 2-methacryloyloxyethyl isocyanate.

The present invention [4] includes the surface modification sheet for silicone rubber described in [2] or [3], wherein the polymer is an adduct, with the isocyanate compound, of a polymer of a monomer component including acrylic monomers containing a hydroxyl group-containing monomer.

The present invention [5] includes the surface modification sheet for silicone rubber described in [4], wherein the polymer contains 2 to 40 parts by mol of the isocyanate compound per 100 parts by mol of the acrylic monomer other than the hydroxyl group-containing monomer.

### Effects of the Invention

The silicone rubber surface modification sheet is suitable to provide a surface modification layer on the surface of a silicone rubber-molded product when a silicone rubber is heat molded. Thus, the silicone rubber surface modification sheet is suitable for efficiently obtaining a silicone rubber-molded product with a modified surface.

In addition, the silicone rubber surface modification sheet modifies a silicone rubber surface with a low polarity by covering the surface. Thus, the sheet is suitable to obtain a high adhesive strength between the silicone rubber-molded product surface and a bonding material, such as a double-sided adhesive tape, by adjusting the monomer composition of the polymer contained in the surface modification layer.

### BRIEF DESCRIPTION OF THE DRAWINGS

FIG. 1 is a cross-sectional schematic view depicting the silicone rubber surface modification sheet of one embodiment of the present invention.

FIG. 2 illustrates an exemplary silicone rubber-molded product with a surface modified using the silicone rubber surface modification.

FIG. 3A illustrates that the surface-modified silicone rubber, a double-sided adhesive tape, and an adherend are prepared. FIG. 3B illustrates that the surface-modified silicone rubber is bonded to the adherend via the double-sided adhesive tape.

### DESCRIPTION OF THE EMBODIMENTS

FIG. 1 is a cross-sectional schematic view depicting a silicone rubber surface modification sheet X of one embodiment of the present invention. The surface modification sheet X is a sheet material for modifying a silicone rubber surface in order to provide, in a metal die molding of silicone rubber, a silicone rubber-molded product with good bondability (in other words, to improve the adhesive strength of a bonding material, such as a double-sided adhesive tape or an adhesive, to the surface of the silicone rubber-molded product). The surface modification sheet X includes a release sheet 10, and a surface modification layer 20 disposed at a side of a one-side surface of the release sheet 10. The surface modification sheet X preferably includes a release sheet 10, and a surface modification layer 20 disposed on the one-side surface of the release sheet 10.

The release sheet 10 is a sheet to ensure the releasability of the surface modification sheet X. Examples of the release sheet 10 include fluorine resin sheet films (for example, “NITOFLON” manufactured by NITTO DENKO(CORPORATION), polyester resin sheets, polymethyl pentene resin sheets (for example, “Opulent” manufactured by Mitsui Chemicals Tohcello, Inc.), and polystyrene resin sheets (for example, “Oidys” manufactured by Kurabo Industries Ltd.).

The release sheet 10 has a thickness of, preferably, 1 μm or more, more preferably, 5 μm or more, even more preferably, 10 μm or more to ensure the handleability of the surface modification sheet X. Meanwhile, the release sheet 10 has a thickness of, preferably, 1000 μm or less, more preferably, 300 μm or less, even more preferably, 200 μm or less to ensure its shape conformability to an inner surface of the metal die.

The release sheet 10 preferably has a heat resistance to 100° C. or more, and preferably has a tensile modulus of elasticity of 1 GPa or less at 100° C.

The surface modification layer 20 is a layer which modifies a silicone rubber-molded product surface by bonding to the surface. The surface modification layer 20 consists of a resin composition containing a polymer (polymer P₁) having a side chain containing an ethylenic double bond. The content of the polymer P₁ in the resin composition is preferably 80% by mass, more preferably 90% by mass to appropriately develop the modification function of the surface modification layer 20.

Examples of a polymer (polymer P₀) making up the main chain of the polymer P₁ include acrylic polymers, polyester polymers, urethane polymers, polyether polymers, and polyamide polymers. The polymer P₀ is preferably an acrylic polymer to ensure the surface modification effect (adhesion facilitating effect) of the surface modification layer 20.

Examples of the acrylic polymer used as the polymer P₀ include polymers obtained by polymerizing monomer components containing 50% by mass or more of alkyl (meth)acrylate (to be more specific, polymers each containing 50% by mass or more units derived from alkyl (meth)acrylate, or (meth)acrylate acid alkyl ester). Used herein, the “(meth)acrylate” refers to acrylate and/or methacrylate. The monomer components contain preferably 60% by mass, more preferably 70% by mass of the alkyl (meth)acrylate to appropriately develop the modification function of the surface modification layer 20.

Examples of the alkyl (meth)acrylate include alkyl (meth)acrylates each having a straight-chain or branched alkyl group having 1 to 20 carbon atoms. Examples of such alkyl (meth)acrylates include methyl(meth)acrylates, ethyl (meth)acrylate, propyl(meth)acrylates, isopropyl(meth)acrylates, butyl(meth)acylates, isobutyl(meth)acrylates, s-butyl(meth)acrylates, t-butyl(meth)acrylates, pentyl(meth)acrylates, isopentyl(meth)acrylates, neopentyl(meth)acrylates, hexyl(meth)acrylates, heptyl(meth)acrylates, 2-ethyl hexyl(meth)acrylates, octyl(meth)acrylates, isooctyl(meth)acrylates, nonyl(meth)acrylates, isononyl(meth)acrylates, decyl(meth)acrylates, isodecyl(meth)acrylates, undecyl(meth)acrylates, dodecyl(meth)acrylates, isotridecyl(meth)acrylates, tetradecyl(meth)acrylates, isotetradecyl(meth)acrylates, pentadecyl(meth)acrylates, hexadecyl(meth)acrylates, heptadecyl(meth)acrylates, octadecyl(meth)acrylates, isooctadecyl(meth)acrylates, nonadecyl(meth)acrylates, and eicosyl(meth)acrylates. The alkyl (meth)acrylates may be used alone or in combination of two or more. To ensure the surface modification effect, the alkyl (meth)acrylate is preferably an alkyl (meth)acrylate having an alkyl group having 2 to 8 carbon atoms, more preferably at least one selected from the group consisting of ethyl (meth)acrylates and butyl(meth)acrylates, even more preferably at least one selected from the group consisting of ethyl acrylates and butyl acrylates.

The monomer components may include one or more other monomer(s) copolymerizable with alkyl (meth)acrylates (copolymerizable monomer(s)). Examples of the copolymerizable monomers include hydroxyl group-containing monomers, carboxyl group-containing monomers, monomers each having a nitrogen atom-containing ring, acid anhydride monomers such as maleic acid anhydride or itaconic acid anhydride, sulfonic acid group-containing monomers, epoxy group-containing monomers, amide group-containing monomers, aromatic vinyl compounds, (meth)acrylic esters each having an alicyclic hydrocarbon group, and (meth)acrylic esters each having an aromatic hydrocarbon group.

Examples of the hydroxyl group-containing monomers include 2-hydroxyethyl(meth)acrylates, 2-hydroxypropyl(meth)acrylates, 2-hydroxybutyl(meth)acrylates, 3-hydroxypropyl(meth)acrylates, 4-hydroxybutyl(meth)acrylates, 6-hydroxyhexyl(meth)acrylates, 8-hydroxyoctyl(meth)acrylates, 10-hydroxydecyl(meth)acrylates, 12-hydroxylauryl(meth)acrylates, and (4-hydroxymethyl cyclohexyl) methyl(meth)acrylates. The hydroxyl group-containing monomer is preferably at least one selected from the group consisting of 2-hydroxyethyl acrylates, 2-hydroxyethyl methacrylates, and 2-hydroxybutyl acrylates.

Examples of the carboxyl group-containing monomers include acrylates, methacrylates, carboxyethyl acrylates, carboxypentyl acrylates, itaconates, maleates, fumarates, crotonates, and isocrotonates.

Examples of the nitrogen atom-containing monomers include N-vinyl-2-pyrrolidones, N-methylvinylpyrrolidones, N-vinylpyridines, N-vinylpiperidones, N-vinylpyrimnidines, N-vinylpiperazines, N-vinylpyrazines, N-vinylpyrrols, N-vinylimidazoles, N-vinyloxazoles, N-(meth)acryloyl-2-pyrrolidones, N-(meth)acryloylpiperidines, N-(meth)acryloylpyrrolidines, N-vinylmorpholines, and N-vinylisothiazoles.

Examples of the sulfonic acid group-containing monomers include styrenesulfonic acids, allyl sulfonic acids, sodium vinylsulfonates, 2-(meth)acrylamide-2-methylpropanesulfonic acids, (meth)acrylamide propanesulfonic acids, sulfopropyl(meth)acrylates, and (meth)acryloyl oxy naphthalene sulfonic acids.

Examples of the epoxy group-containing monomers include epoxy group-containing acrylates such as glycidyl (meth)acrylate and (meth)acrylate-2-ethyl glycidyl ether, allyl glycidyl ethers, and (meth)acrylate glycidyl ethers.

Examples of the amide group-containing monomers include (meth)acrylamides, N-alkyl(meth)acrylamides, N,N-dialkyl(meth)acrylamides, and N-(meth)acryloylmorpholines. Examples of the N-alkyl(meth)acrylamides include N-ethyl(meth)acrylamides, N-isopropyl(meth)acrylamides, and N-butyl(meth)acrylamides. Examples of the N,N-dialkyl(meth)acrylamides include N,N-dimethyl(meth)acrylamides, N,N-diethyl(meth)acrylamides, N,N-dipropyl(meth)acrylamides, and N,N-diisopropyl(meth)acrylamides.

Examples of the aromatic vinyl compounds include styrenes. α-methylstyrenes, and vinyl toluenes.

Examples of the (meth)acrylic esters each having an alicyclic hydrocarbon group include cyclopentyl(meth)acrylates, cyclohexyl(meth)acrylates, isobornyl(meth)acrylates, and dicyclopentanyl(meth)acrylates.

Examples of the (meth)acrylic esters each having an aromatic hydrocarbon group include phenyl(meth)acrylates, phenoxyethyl(meth)acrylates, and benzyl(meth)acrylates.

Preferred examples of the copolymerizable monomers include copolymerizable monomers each having a functional group (first functional group) that can react with a second functional group described below. Specific examples of such copolymerizable monomers include hydroxyl group-containing monomers and carboxyl group-containing monomers.

The monomer components contain the copolymerizable monomer in an amount of preferably 1 part by mol or more, more preferably 5 parts by mol or more and preferably 50 parts by mol or less, more preferably 40 parts by mol or less per 100 parts by mol of the alkyl (meth)acrylate.

The acrylic polymer used as the polymer P₀ preferably consists of an alkyl (meth)acrylate and a copolymerizable monomer containing the first functional group.

The acrylic polymer can be formed by polymerizing the monomer components. Examples of the polymerization method include solution polymerization, bulk polymerization, and emulsion polymerization. Solution polymerization is preferred. In solution polymerization, for example, a reaction solution is prepared by blending the monomer components and a polymerization initiator in a solvent. Thereafter, the reaction solution is heated. A polymerization reaction of the monomer components occurring in the reaction solution produces an acrylic polymer solution including the acrylic polymer. Depending on the polymerization method, a thermal polymerization initiator or a photopolymerization initiator can be used as the polymerization initiator. The polymerization initiator is used in an amount of, for example, 0.01 parts by mass or more and, for example, 5 parts by mass or less relative to 100 parts by mass of the monomer components.

Examples of the thermal polymerization initiator include azo-based polymerization initiators, peroxide-based polymerization initiators, and salts of persulfuric acid such as potassium persulfate. Examples of the azo-based polymerization initiators include 2,2′-azobisisobutyronitriles, 2,2′-azobis-2-methylbutyronitriles, dimethyl 2,2′-azobis (2-methylpropionates), 4,4′-azobis-4-cyanovaleric acids, azobisisovaleronitriles, and 2,2′-azobis (2-amidinopropane) dihydrochlorides. Examples of the peroxide-based polymerization initiators include dibenzoyl peroxides, t-butyl permaleates, and lauroyl peroxides.

Examples of the photopolymerization initiator include benzoin ether-based photopolymerization initiators, acetophenone-based photopolymerization initiators, λ-ketol-based photopolymerization initiators, aromatic sulfonyl chloride-based photopolymerization initiators, photoactive oxime-based photopolymerization initiators, benzoine-based photopolymerization initiators, benzyl-based photopolymerization initiators, benzophenone-based photopolymerization initiators, ketal-based photopolymerization initiators, thioxanthone-based photopolymerization initiators, and acylphosphine oxide-based photopolymerization initiators.

An exemplary method for introducing a side chain containing an ethylenic double bond to the acrylic polymer is as follows. An acrylic polymer is obtained by polymerizing monomer components containing an alkyl (meth)acrylate and a monomer which can be copolymerized with alkyl (meth)acrylate and has a predetermined functional group (the first functional group). Thereafter, an addition reaction is carried out to add a compound to the acrylic polymer, where the compound contains an ethylenic double bond and a predetermined functional group (the second functional group) which can react with and bond to the first functional group, while the ethylenic double bond is preserved in the addition reaction.

Examples of the combination of the first functional group and second functional group include a combination of a hydroxyl group and an isocyanate group, a combination of an isocyanate group and a hydroxyl group, a combination of a carboxyl group and an epoxy group, and a combination of an epoxy group and a carboxyl group. Among the combinations, a combination in which the first functional group of the acrylic polymer is a hydroxyl group and the second functional group is an isocyanate group is preferred to easily produce or obtain the polymer P₁. In other words, the polymer P₁ is preferably an adduct of a polymer with the isocyanate compound in which the polymer is made up of monomer components including a hydroxyl group-containing monomer. The polymer P₁ is more preferably an adduct, with the isocyanate compound, of a polymer of monomer components including acrylic monomers containing a hydroxyl group-containing monomer. In such a case, the side chains of the polymer P₁ include a unit derived from the isocyanate compound containing an ethylenic double bond.

Examples of the compound having the ethylenic double bond and an isocyanate group that works as the second functional group, or, examples of the isocyanate compound containing the ethylenic double bond include 2-methacryloyloxyethyl isocyanates (MOI), and isocyanic acid 3-isopropenyl-α,α-dimethylbenzyls. For ease introduction of an ethylenic double bond to the side chain of the polymer, MOI is preferred as the isocyanate compound containing the ethylenic double bond.

Provided that the polymer P₁ is an adduct, with the isocyanate compound, of a polymer of monomer components including acrylic monomers containing a hydroxyl group-containing monomer, the addition reaction of the polymer P₀ and the ethylenic double bond-containing isocyanate compound is carried out so that the hydroxyl group (the first functional group) of the polymer P₀ and the isocyanate group (the second functional group) in the ethylenic double bond-containing isocyanate compound are contained in a predetermined ratio in the polymer P₁.

Provided that the polymer P₁ is an adduct, with the isocyanate compound, of a polymer of monomer components including acrylic monomers containing a hydroxyl group-containing monomer, the monomer components contain preferably 2 parts by mol or more, more preferably 10 parts by mol or more, even more preferably 15 parts by mol or more of the isocyanate compound per 100 parts by mol of the acrylic monomer other than the hydroxyl group-containing monomer to ensure the bonding strength of the surface modification layer 20 to the silicone rubber, and contain preferably 40 parts by mol or less of the isocyanate compound per 100 parts by mol of the acrylic monomer other than the hydroxyl group-containing monomer to save the cost.

Provided that the polymer P₁ is an adduct, with the isocyanate compound, of a polymer of monomer components including acrylic monomers containing a hydroxyl group-containing monomer, the molar ratio of the isocyanate compound to the hydroxyl group-containing monomer is preferably 0.5 or more, more preferably 0.6 or more, even more preferably 0.8 or more, particularly preferably 1 in the monomer components to ensure the surface modification effect.

The addition reaction is carried out at a reaction temperature of, for example, 40° C. to 60° C. for a reaction time of, for example, 4 to 6 hours. An addition reaction catalyst may be used for the addition reaction. Provided that the combination of the first functional group and second functional group is a hydroxyl group and art isocyanate group, for example, dibutyltin dilaurate may be used as the addition reaction catalyst. The addition reaction catalyst is used in an amount of, for example, 0.3 to 0.6 parts by mass relative to 100 parts by mass of the ethylenic double bond-containing isocyanate compound.

The polymer P₁ has a weight-average molecular weight of preferably 100(00) or more, more preferably 300000 or more to ensure the film-forming properties and processability of the resin composition, and preferably 5000000 or less, more preferably 3000000 or less to ensure the coatability of the resin composition. The weight-average molecular weight of the acrylic polymer is measured by Gel Permeation Chromatography (GPC) and calculated using standard polystyrene as the calibration curve.

The resin composition may contain another component in addition to the polymer P₁ as necessary. Examples of the additional component include pH adjusters, cross-linking agents, viscosity modifiers (such as thickening agents), leveling agents, peeling adjusters, plasticizing agents, softeners, tillers, coloring agents (such as pigments and colorants), surfactants, antistatic agents, preservative agents, anti-aging agents, ultraviolet absorbing agents, antioxidizing agents, and light stabilizers.

The surface modification layer 20 has a thickness of preferably 5 μm or more, more preferably 10 μm or more, even more preferably 15 μm or more to ensure the surface modification effect, and preferably 200 μm or less, more preferably 10 μm or less, even more preferably 50 μm or less to ensure the surface modification effect.

The surface modification sheet X can be produced by, for example, applying a resin composition containing various components for forming the surface modification layer 20 onto the release sheet 10 to form a coating film, and drying the coating film to remove the solvent therefrom as necessary. Examples of the method of applying the resin composition include roll coating, kiss roll coating, gravure coating, reverse roll coating, roll brush coating, spray coating, dip roll coating, bar coating, knife coating, air knife coating, curtain coating, lip coating, and die coating. To remove the solvent, the coating film is dried, for example, at 50° C. to 200° C. for 5 seconds to 10 minutes.

The produced surface modification sheet X may be laminated with a peeling film, or release liner, on a surface 21 of the surface modification layer 20 as necessary. Examples of the peeling film include flexible plastic films such as polyethylene films, polypropylene films, polyethylene terephthalate films, and polyester films.

Using the surface modification sheet X, the surface modification layer 20 can be provided on a silicone rubber-molded product surface when the silicone rubber is molded in a metal die. To be more specific, the surface modification sheet X is laminated on an uncured silicone rubber so that the surface modification layer 20 faces the uncured silicone rubber. The uncured silicone rubber with the sheet is disposed in a metal die and the metal die is heated to mold the silicone rubber. Alternatively, the surface modification sheet X is disposed in a metal die in advance so that the surface modification layer 20 can face the uncured silicone rubber to be provided in the metal die. Then, the metal die is heated to mold the silicone rubber. Such heat molding allows for efficient integration of the surface modification layer 20 with the silicone rubber-molded product surface at the same time as the molding of the silicone rubber, while allowing the release sheet to ensure the releasability of the surface modification layer 20 from the metal die. Efficient implementation of the molding and surface modification of the silicone rubber is preferred to improve the yield and save the cost in manufacturing of the silicone rubber-molded products.

Examples of the molding method include plate press molding, compression molding, and injection molding. Depending on the molding method, a variety of molding machines such as a plate molding machine, a compression molding machine, and an injection molding machine can be used. The press plates of a plate molding machine, or a metal die having predetermined asperities on its inner surface may be used as the metal die for the heat molding.

The molding is carried out at, for example, a pressure of 20 MPa. The metal die is heated at, for example, 100° C. to 400° C. After the heat molding, a secondary heating of the silicone rubber-molded product may be carried out. The secondary beating is carried out, for example, at 200° C. to 220° C. for 1 to 4 hours. Before or after the secondary heating, the release sheet 10 is peeled from the surface modification layer 20 integrated with the silicone rubber-molded product (as a result, the surface modification layer 20 is transferred onto the silicone rubber-molded product surface).

The ethylenic double bond that the polymer P₁ has at its side chain in the surface modification layer 20 is suitable to cause a chemical reaction and form a chemical bonding to the silicone rubber during the heat molding, and thus suitable to ensure the bonding strength of the surface modification layer 20 to the silicone rubber.

The surface modification sheet X modifies a silicone rubber surface with a low polarity by covering the surface. The surface modification sheet X is suitable to obtain a high bondability with a bonding material, such as a double-sided adhesive tape, by adjusting the monomer composition of the polymer P₁ contained in the surface modification layer 20.

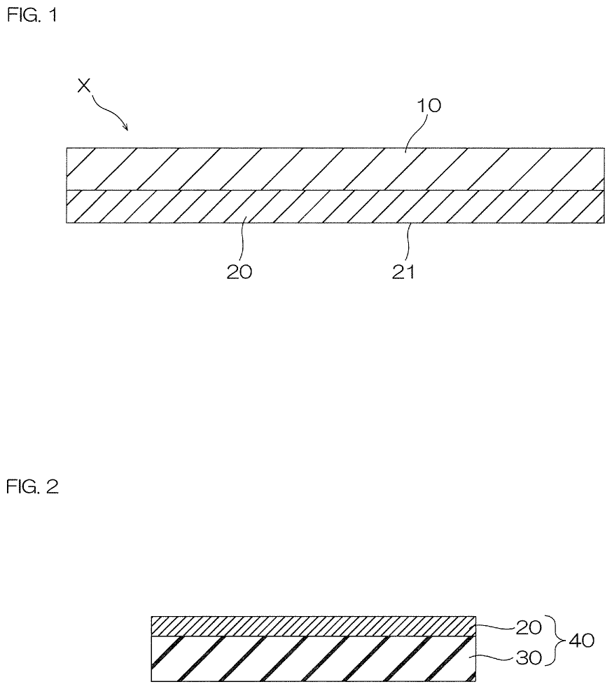

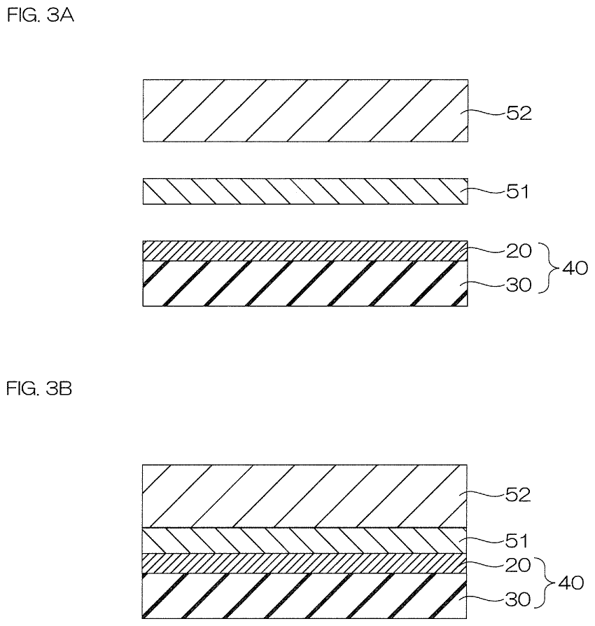

FIG. 2 illustrates a surface-modified silicone rubber 40 as an exemplary silicone rubber-molded product with a surface modified using the surface modification sheet X. The surface-modified silicone rubber 40 is a silicone rubber-molded product 30 provided together with the surface modification layer 20. For example, as illustrated in FIG. 3A, the surface-modified silicone rubber 40 is prepared together with a double-sided adhesive tape 51 and an adherend 52. Thereafter, as illustrated in FIG. 3B, the surface-modified silicone rubber 40 is bonded via the double-sided adhesive tape 51 to the adherend 52. The surface modification layer 20 ensures the bonding strength of the double-sided adhesive tape 51 to the surface-modified silicone rubber 40. Thus, the surface-modified silicone rubber 40 is appropriately bonded to the adherend 52.

### EXAMPLES

### Example 1

### <Preparation of First Polymer>

In a reaction container including a separable cover, a separating funnel, a thermometer, a nitrogen gas introducing tube, a Liebig condenser, a vacuum sealer, and an agitator, a mixture containing 50 parts by mol of ethyl acrylate (EA), 50 parts by mol of butyl acrylate (BA), 5 parts by mol of 2-ethyl hexyl acrylate (HEA), 0.5 parts by mass of 2,2′-azobisisobutyronitrile as a polymerization initiator relative to 100 parts by mass of the monomer components EA, BA and HEA, and ethyl acetate as a polymerization solvent was stirred at 62° C. for 3 hours under nitrogen atmosphere and thereafter stirred at 75° C. for 2 hours (polymerization reaction). In this manner, a polymer solution containing an acrylic polymer A₁ as the first polymer was obtained.

### <Preparation of Second Polymer>

Next, the reaction solution containing the polymer solution containing the acrylic polymer A₁, 2-methacryloyloxyethyl isocyanate (MOI) (the trade name “Karenz MOI”, manufactured by SHOWA DENKO K.K.), and dibutyltin dilaurate (manufactured by FUJIFILM Wako Pure Chemical Corporation) as an addition reaction catalyst was stirred at 50° C. for 5 hours under air atmosphere (addition reaction). The reaction solution contained 2.5 parts by mol of the MOI per 100 parts by mol of the EA and BA in total. The reaction solution also contained 0.5 parts by mass of the dibutyltin dilaurate per 100 parts by mass of the MOI. The addition reaction produced a composition used for a surface modification layer and containing an acrylic polymer A₂ having an ethylenic double bond at its side chain (the acrylic polymer to which the ethylenic double bond-containing isocyanate compound was added).

### <Production of Surface Modification Sheet>

The surface modification layer composition was applied onto a polytetrafluoroethylene film (the trade name “NITOFLON No. 900 UL”, a thickness of 50 μm, manufactured by NITTO DENKO CORPORATION) prepared as a peeling sheet, thereby forming a coating film. The coating film was dried at 120° C. for 3 minutes in a drying treatment, and thereby forming a surface modification layer with a thickness of 25 μm on the peeling sheet. In this manner, the silicone rubber surface modification sheet of Example 1 was produced. The compositions of the second polymer in Example 1 are shown in Table 1 in which the unit of the numerical values of each composition is “parts by mol”.

### Examples 2 to 4

The silicone rubber surface modification sheets of Examples 2 to 4, each having a surface modification layer with a thickness of 25 μm, were produced in a procedure similar to that for the silicone rubber surface modification sheet of Example 1, except for changing the used amount of MOI, instead of 2.5 parts by mol, to 3 parts by mol (in Example 2), 4 parts by mol (in Example 3), or 5 parts by mol (in Example 4) in the preparation of the second polymer.

### Examples 5 to 8

The silicone rubber surface modification sheets of Examples 5 to 8, each having a surface modification layer with a thickness of 25 μm, were produced in a procedure similar to that for the silicone rubber surface modification sheet of Example 1, except for changing the used amount of HEA to 10 parts by mol (in Examples 5 to 8) instead of 5 parts by mol in the preparation of the first polymer, and except for changing the used amount of MOI, instead of 2.5 parts by mol, to 5 parts by mol (in Example 5), 6 parts by mol (in Example 6), 8 parts by mol (in Example 7), or 10 parts by mol (in Example 8) in the preparation of the second polymer.

### Examples 9 to 12

The silicone rubber surface modification sheets of Examples 9 to 12, each having a surface modification layer with a thickness of 25 μm, were produced in a procedure similar to that for the silicone rubber surface modification sheet of Example 1, except for changing the used amount of HEA, instead of 5 parts by mol, to 20 parts by mol (in Examples 9 to 12) in the preparation of the first polymer, and except for changing the used amount of MOI, instead of 5 parts by mol, to 10 parts by mol (in Example 9), 12 parts by mol (in Example 10), 16.6 parts by mol (in Example 11), or 20 parts by mol (in Example 12) in the preparation of the second polymer.

### Examples 13 to 16

The silicone rubber surface modification sheets of Examples 13 to 16, each having a surface modification layer with a thickness of 25 μm, were produced in a procedure similar to that for the silicone rubber surface modification sheet of Example 1, except for changing the used amount of HEA, instead of 5 parts by mol, to 40 parts by mol (in Examples 13 to 16) in the preparation of the first polymer, and except for changing the used amount of MOI, instead of 5 parts by mol, to 20 parts by mol (in Example 13), 24 parts by mol (in Example 14), 32 parts by mol (in Example 15), or 40 parts by mol (in Example 16) in the preparation of the second polymer.

### Comparative Example 1

In a reaction container including a separable cover, a separating funnel, a thermometer, a nitrogen gas introducing tube, a Liebig condenser, a vacuum sealer, and an agitator, a mixture containing 50 parts by mol of ethyl acrylate (EA), 50 parts by mol of butyl acrylate (BA), 5 parts by mol of 2-ethyl hexyl acrylate (HEA), 0.5 parts by mass of 2,2′-azobisisobutyronitrile as a polymerization initiator relative to 100 parts by mass of the monomer components EA, BA and HEA, and ethyl acetate as a polymerization solvent was stirred at 62° C. for 3 hours under nitrogen atmosphere and thereafter stirred at 75° C. for 2 hours (polymerization reaction). In this manner, a polymer solution containing an acrylic polymer A₁ as the first polymer was obtained. Next, the polymer solution containing the acrylic polymer A₁ was applied onto a polytetrafluoroethylene film (the trade name “NITOFILON No. 900 UL”, a thickness of 50 μm, manufactured by NITTO DENKO CORPORATION) prepared as a peeling sheet, thereby forming a coating film. Thereafter, the coating film was dried at 120° C. for 3 minutes in a drying treatment, and thereby forming a surface modification layer with a thickness of 25 μm on the peeling sheet. In this manner, the surface modification sheet of (Comparative Example 1 was produced.

### Comparative Examples 2 to 4

The surface modification sheets of Comparative Examples 2 to 4, each having a surface modification layer with a thickness of 25 μm, were produced in a procedure similar to that for the surface modification sheet of Comparative Example 1, except for changing the used amount of HEA, instead of 5 parts by mol, to 10 parts by mol (in Comparative Example 2), 20 parts by mol (in Comparative Example 3), or 40 parts by mol (in Comparative Example 4) in the preparation of the acrylic polymer A₁.

### <Modification of Silicone Rubber Surface>

A silicone rubber surface was modified as described below using the surface modification sheet of each of Examples 1 to 16 and Comparative Examples 1 to 4.

The surface modification sheet (150 mm×150 mm), a sheet-shaped uncured silicone rubber (120 mm×115 mm, thickness of 3 mm) on the surface modification sheet, and a metal die were disposed on the lower press plate of a plate press machine (the trade name “Hot press 30 Ton”, manufactured by TESTER SANGYO CO., LTD.). The surface modification layer of the surface modification sheet faced the uncured silicone rubber. The metal die had a rectangular frame shape in plan view. The inner rectangular shape of the frame had a size of 155 mm-155 mm, the frame width was 23 mm, and the frame thickness was 2 mm. The uncured silicone rubber consisted of a mixture of 100 parts by mass of silicone rubber in a raw state (the trade name “KE9490-U”, manufactured by Shin-Etsu Chemical Co., Ltd.) and 2 parts by mass of a vulcanizing agent (the trade name “C-8”, manufactured by Shin-Etsu Chemical Co., Ltd.), and was placed on the surface modification sheet surrounded by the frame-shaped metal die.

Next, the plate press machine was used to heat press the surface modification sheet and the silicone rubber between its lower and upper plates (primary heating). The press was carried out at a pressure of 20 MPa and a temperature of 175° C. for 7 minutes.

Next, the silicone rubber heat pressed together with the surface modification sheet was heated under normal pressure in an oven (secondary heating). The heating was carried out at a temperature of 200° C. for 4 hours. In this manner, a surface-modified silicone rubber was obtained.

### <Evaluation of Adhesive Strength>

The adhesive strength of an adhesive tape specimen to the surface-modified silicone rubber obtained using the surface modification sheet of each of Examples 1 to 16 and Comparative Examples 1 to 4 was evaluated.

The adhesive tape specimen was produced from a double-sided adhesive tape including a release liner on both sides (the trade name “VR-5300” manufactured by NITTO DENKO CORPORATION). First, a release liner (the first release liner) covering one adhesive surface of the double-sided adhesive tape was peeled off at a temperature of 23° C. and a relative humidity of 50%. A PET film (the trade name “Lumirror #25-S10”, manufactured by TORAY INDUSTRIES, INC.) was adhered to the adhesive surface exposed by the peeling. In this manner, a laminate of the PET film, the adhesive tape, and the release liner (the second release liner) covering the other adhesive surface was obtained. Next, three adhesive tape specimens with a size of 80 mm×20 mm were cut out from the laminate.

Next, the second release liner was peeled off from the adhesive tape specimen. Thereafter, the exposed adhesive surface of the adhesive tape specimen was adhered to the modified surface of the surface-modified silicone rubber as an adherend, by pressure bonding operation of reciprocating a 2 Kg roller once. Thereafter, the adhesive tape specimen on the adherend was left at a temperature of 23° C. and a relative humidity of 50% for 30 minutes.

Next, a tensile test machine (the trade name “Autograph AG-IS”, manufactured by SHIMADZU CORPORATION) was used to measure the 180° peeling strength of the adhesive tape specimen to the adherend in conformity with JIS Z 0237: 2009. The measurement was carried out at a peeling temperature of 23° C., a peeling angle of 180°, and a tensile rate, or peeling rate, of 300 mm/min. The measurement was carried out three times in total for each set of the three adhesive tape specimens. The average of the three measured values is shown as the peeling strength (N/20 mm) in Table 1.

TABLE 1

| | | | | | Peeling |
|---|---|---|---|---|---|
| | | | | | strength |
| | EA | BE | HEA | MOI | (N/20 mm) |
| Example 1 | 50 | 50 | 5 | 2.5 | 11.9 |
| Example 2 | 50 | 50 | 5 | 3 | 14.2 |
| Example 3 | 50 | 50 | 5 | 4 | 11.8 |
| Example 4 | 50 | 50 | 5 | 5 | 12.5 |
| Example 5 | 50 | 50 | 10 | 5 | 9.7 |
| Example 6 | 50 | 50 | 10 | 6 | 9.3 |
| Example 7 | 50 | 50 | 10 | 8 | 9.7 |
| Example 8 | 50 | 50 | 10 | 10 | 13.0 |
| Example 9 | 50 | 50 | 20 | 10 | 12.4 |
| Example 10 | 50 | 50 | 20 | 12 | 12.5 |
| Example 11 | 50 | 50 | 20 | 16.6 | 15.5 |
| Example 12 | 50 | 50 | 20 | 20 | 17.3 |
| Example 13 | 50 | 50 | 40 | 20 | 12.4 |
| Example 14 | 50 | 50 | 40 | 24 | 13.5 |
| Example 15 | 50 | 50 | 40 | 32 | 15.5 |
| Example 16 | 50 | 50 | 40 | 40 | 17.3 |
| Comparative | 50 | 50 | 5 | 0 | 6.9 |
| Example 1 | | | | | |
| Comparative | 50 | 50 | 10 | 0 | 5.4 |
| Example 2 | | | | | |
| Comparative | 50 | 50 | 20 | 0 | 8.2 |
| Example 3 | | | | | |
| Comparative | 50 | 50 | 40 | 0 | 8.2 |
| Example 4 | | | | | |

### INDUSTRIAL APPLICABILITY

The silicone rubber surface modification sheet of the present invention can be used as a material to modify a surface of a silicone rubber-molded product to facilitate its bonding.

### DESCRIPTION OF REFERENCE NUMERALS

X surface modification sheet (the surface modification sheet for silicone rubber)
10 release sheet
20 surface modification layer
30 silicone rubber
51 double-sided adhesive tape
52 adherend

1. A surface modification sheet for silicone rubber, the surface modification sheet comprising:
a release sheet; and
a surface modification layer disposed on the release sheet, and containing a polymer having a side chain containing an ethylenic double bond.

2. The surface modification sheet for silicone rubber according to claim 1, wherein the side chain includes a unit derived from an isocyanate compound containing the ethylenic double bond.

3. The surface modification sheet for silicone rubber according to claim 2, wherein the isocyanate compound is 2-methacryloyloxyethyl isocyanate.

4. The surface modification sheet for silicone rubber according to claim 2, wherein the polymer is an adduct, with the isocyanate compound, of a polymer of a monomer component including acrylic monomers containing a hydroxyl group-containing monomer.

5. The surface modification sheet for silicone rubber according to claim 4, wherein the polymer contains 2 to 40 parts by mol of the isocyanate compound per 100 parts by mol of the acrylic monomer other than the hydroxyl group-containing monomer.

6. The surface modification sheet for silicone rubber according to claim 3, wherein the polymer is an adduct, with the isocyanate compound, of a polymer of a monomer component including acrylic monomers containing a hydroxyl group-containing monomer.
